(19) United States
(12) Patent Application Publication
(10) Pub. No.: US 2025/0370123 A1
(43) Pub. Date: Dec. 4, 2025

(54) SAFETY SYSTEM INSIDE SCHOOL VEHICLE USING RADAR SENSOR

(71) Applicant: SMART RADAR SYSTEM, INC., Seongnam-si (KR)

(72) Inventors: Young Woo JEONG, Suwon-si (KR); Yong Jae KIM, Yongin-si (KR)

(73) Assignee: SMART RADAR SYSTEM, INC., Seongnam-si (KR)

(21) Appl. No.: 19/220,195

(22) Filed: May 28, 2025

(30) Foreign Application Priority Data
May 29, 2024 (KR) 10-2024-0070298

(51) Int. Cl. G01S 13/88; G01S 7/41

(52) U.S. Cl. CPC G01S 13/886; G01S 7/411

(57) ABSTRACT

A safety system inside a school vehicle using a radar sensor according to one aspect of the present invention comprises a plurality of side radar sensor modules installed on one side wall at a height corresponding to seat level for each row of seats with detection areas divided into sectors corresponding to seat positions to detect human bio-signals, upper radar sensor modules, an alarm indicator that receives bio-signal detection results from the radar sensor modules to determine alarm generation and outputs warning sounds through a speaker while flashing LEDs when an alarm is triggered, and a power supply device that switches between operating and sleep modes according to the vehicle's power status to supply power to the radar sensor modules and alarm indicator, thereby preventing accidents by detecting bio-signals of children remaining inside the school vehicle and generating alarms.

### CROSS-REFERENCE TO RELATED APPLICATION(S)

This application claims priority from Korean Patent Application No. 10-2024-0070298, filed on May 29, 2024, in the Korean Intellectual Property Office, the disclosure of which is incorporated herein by reference in its entirety.

### BACKGROUND

### 1. Field

The following description relates to a safety management technology for a school vehicle, and more specifically, to a technology for detecting bio-signals of a human inside the school vehicle using a radar sensor.

### 2. Description of Related Art

Educational institutions such as schools operate school vehicles such as school buses to provide transportation for children. However, accidents have occurred due to a failure to properly check whether all children have disembarked from the school vehicle, or a failure to notice children approaching the school vehicle or in particular, children who have entered a space under the vehicle when the vehicle begins to depart.

Korean Registered Patent No. 10-1388689 discloses a technology of preventing an accident by installing an RF receiving terminal inside a school vehicle and providing a child using a school vehicle with an RF signal emitting terminal such that a driver may recognize whether the child boards or disembarks from the vehicle and whether the RF emitting terminal moves outside a set area upon disembarkation thereof. Such a conventional technology may have a limitation in detecting children approaching the school vehicle when the children do not bring the RF emitting terminal or are temporarily separated from the RF signal emitting terminal (e.g., when the RF signal emitting terminal is attached to a bag but the bag is placed separately).

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to a safety system capable of detecting bio-signals of a child remaining inside a school vehicle without disembarking from the school vehicle and generating an alarm using radar.

In one general aspect, a safety system inside a school vehicle using a radar sensor includes: a plurality of side radar sensor modules, an alarm indicator, and a power supply device.

The side radar sensor module is installed as a plurality of side radar sensor modules such that the plurality of side radar sensor modules are installed on one side wall inside a school vehicle at a height corresponding to a seat level for each row of seats, and configured to detect a bio-signal of a human with respect to a lower side of the seat in a direction toward the other side wall, wherein an object detection area is divided into sectors corresponding to a position of each of the seats to detect the bio-signal.

The alarm indicator is configured to receive a bio-signal detection result from the radar sensor modules and determine whether an alarm has been generated from the inside of the school vehicle, and when it is determined that the alarm has been generated from the inside of the school vehicle, outputs a warning sound through a speaker and flashes one or more light emitting diodes (LEDs) to indicate the generation of the alarm.

The power supply device is configured to, when the school vehicle is turned on, receive power from the school vehicle, activate from a sleep mode, and supply power to the radar sensor module and the alarm indicator, and when the school vehicle is turned off and a first time period has elapsed, stop supplying power to the radar sensor module and the alarm indicator, and switch to a sleep mode to standby.

In an additional general aspect, the safety system inside the school vehicle may further include a plurality of upper radar sensor modules.

The upper radar sensor module may be installed on an upper portion of one side wall inside the school vehicle to detect a bio-signal of a human with respect to an upper side of the seat.

In various general aspects, the power supply device transmits a bio-signal detection start control message with respect to the inside of the school bus to the alarm indicator when the school vehicle is turned off, and the alarm indicator transmits the bio-signal detection start control message to the radar sensor modules installed inside the school vehicle during a preset first cycle.

The alarm indicator may transmit the bio-signal detection start control message to the radar sensor modules installed inside the school vehicle after waiting for a second period of time.

In various general aspects, the plurality of radar sensor modules, the power supply device, and the alarm indicator may be connected in a daisy chain form through a vehicle network.

In various general aspects, the alarm indicator may transmit a power reset control message to reset power of a specific radar sensor module through an in-vehicle network communication, and the radar sensor module having received the power reset control message from the alarm indicator may perform a power reset.

In various general aspects, the alarm indicator, when at least one of the plurality of radar modules detects the bio-signal inside the school vehicle, notifies a control server of a result of the detection through a mobile data terminal (MDT) inside the school vehicle.

Other features and aspects will be apparent from the following detailed description, the drawings, and the claims.

### BRIEF DESCRIPTION OF THE DRAWINGS

FIG. 1 is a block diagram of a safety system inside a school vehicle using a radar sensor according to an embodiment of the present invention.

FIG. 2 illustrates an example of radar sensor modules that are installed in a school vehicle according to an embodiment of the present invention.

FIG. 3 conceptually illustrates an example of each component according to the present invention that is connected through a vehicle network.

Throughout the drawings and the detailed description, unless otherwise described, the same drawing reference numerals will be understood to refer to the same elements, features, and structures. The relative size and depiction of these elements may be exaggerated for the sake of clarity, illustration, and convenience.

### DETAILED DESCRIPTION

The foregoing and additional aspects are embodied through embodiments described with reference to the attached drawings. It is understood that various combinations of the components of each embodiment are possible within the embodiment as long as there is no other mention or contradiction between them. In some cases, each block in a block diagram may represent a physical part, but in other cases, it may be a logical expression of a part of the function of one physical part or a function across multiple physical parts. Sometimes the entity of a block or part of the block may be a set of program instructions. All or some of these blocks may be implemented by hardware, software, or a combination thereof.

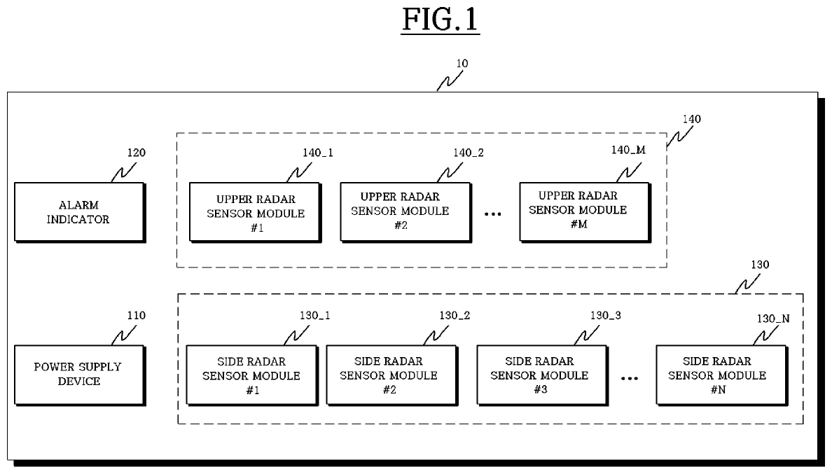

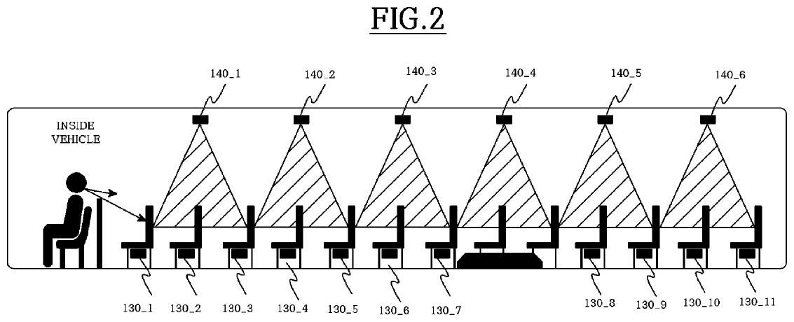

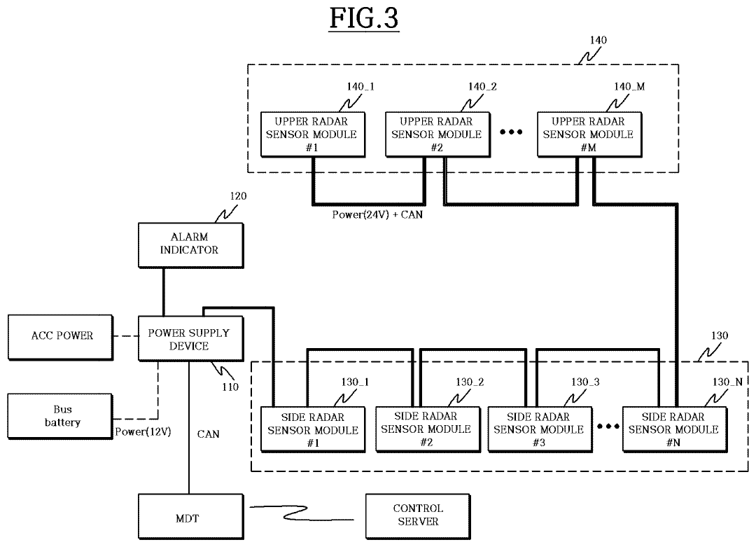

FIG. 1 is a block diagram illustrating a safety system inside a school vehicle using a radar sensor according to an embodiment of the present invention, FIG. 2 illustrates an example in which radar sensor modules are installed in a school vehicle according to an embodiment of the present invention, and FIG. 3 conceptually illustrates an example in which respective components of the present invention are connected via a vehicle network.

A safety system 10 inside a school vehicle using a radar sensor according to one aspect of the present invention includes a plurality of side radar sensor modules 130, an alarm indicator 120, and a power supply device 110.

The components shown in FIG. 1 are connected via a vehicle network. For example, the components shown in FIG. 1 may be connected via a controller area network (CAN). However, the present invention is not limited thereto, and each of the components shown in FIG. 1 may be connected by other methods and connected via a local interconnect network (LIN), FlexRay, Ethernet, etc.

The safety system 10 inside a school vehicle according to the present invention is preferably applied to a relatively large vehicle, such as a school bus. The present invention is not limited thereto, and the safety system 10 inside a school vehicle according to the present invention may be applied to a passenger vehicle.

A school vehicle generally includes seats arranged in an m×n configuration. For example, the school vehicle may include seats arranged such that 52 people (53 people when the last row has 5 seats) may board in 13 rows (n is 13) with 2 seats on each side (m is 4) of a center aisle. In this case, since the present invention includes a side radar sensor module 130 installed for each row, a total of 13 side radar sensor modules 130 may be installed. That is, the side radar sensor module is installed for each row in which seats are arranged in the vehicle, and has a lower side of a seat for each row as a detection area. However, as shown in FIG. 2, the vehicle has 13 rows of seats, but when a child is unable to enter a space under a seat due to a protrusion of a rear wheel, the side radar sensor module 130 may not be installed for space under a row of the corresponding seat.

The radar used by the side radar sensor module 130 is an ultra-short range radar (USSR) or a short range radar (SSR). There is no limitation on the radar operation method of the side radar sensor module 130, and a pulse Doppler method, a frequency modulated continuous wave (FMCW) method, a frequency shift keying (FSK) method, a Ultra-Wideband (UWB) method, or the like may be used.

The side radar sensor module 130 is installed on one side wall to face the other side wall inside the school vehicle at a height corresponding to a seat level for each row of seats and detects a bio-signal of a human with respect to a lower side of the seat in a direction toward the other side wall.

The side radar sensor module 130 is installed below the seat near the height at which the seat is installed, and has a detection area that may allow detection of a child who has entered a space under the seat.

In addition, the radar of the side radar sensor module 130 may be a radar having a field of view (FOV) that has the entire area of the installed seat row as a monitoring area, but is not limited thereto. That is, the detection area of the side radar sensor module 130 installed in a specific seat row may partially overlap the detection area of the side radar sensor module 130 installed in an adjacent seat row.

Upon detecting an object whose bio-signal is detected inside the vehicle, i.e., a child riding in the vehicle, each of the side radar sensor modules 130 reports an object detection result through the connected vehicle network. In this case, each of the side radar sensor modules 130 may attempt to perform bio-signal detection for a preset set time (e.g., 30 seconds).

According to an aspect of the invention, the side radar sensor module 130 may detect the bio-signal by dividing an object detection area in a direction from one side wall to the other side wall into sectors based on each seat position.

The side radar sensor module 130 may be installed on one side wall to face the other side wall inside the school vehicle, and divides an area corresponding to the positions of the seats in each row into sectors, and may detect the bio-signal in each sector. The side radar sensor module 130 divides the inside of the school vehicle into sectors according to as many as the number of seats there are in the width direction and detects the bio-signal. For example, when four seats are installed in a single row, the side radar sensor module 130 may divide the inside of the vehicle into four sectors and detect bio-signals in each sector.

The side radar sensor module 130 may be implemented as a radar and a signal processing circuit connected to an output terminal of the radar or a computing device including a signal processing circuit.

The side radar sensor module 130 includes a radar signal processing unit including a radar circuit and a digital signal processing (DSP) which is an application processor, and the radar signal processing unit processes radar signals, which are output through a plurality of transmitting antennas, reflected from a target, and received by a plurality of receiving antennas, and outputs output data including Doppler effect, distance data, and point cloud data.

The radar signal processing unit sequentially emits radar waveform signals to the interior space of the vehicle through the plurality of transmitting antennas and processes signals received through the plurality of receiving antennas and outputs the processed signals.

The transmitting antenna and the receiving antenna may be patch array antennas.

The radar generates a radar waveform signal through a variable frequency oscillator according to a modulation/demodulation control signal. For example, the radar generates and outputs a frequency-modulated continuous wave radar (FMCW) radar waveform signal, referred to as a chirp, of which the frequency linearly increases and decreases for a period according to a modulation control signal through a variable frequency oscillator. The radar emits the radar waveform signal to the interior space of the vehicle through a transmitting antenna.

The radar waveform signal emitted through the transmitting antenna is reflected from the target and received by the receiving antenna.

The radar of the side radar sensor module 130 performs low-noise amplification and demodulation on the radar waveform signal received through the receiving antenna, converts the signal into a baseband signal, and then converts the baseband signal into a digital signal through analog-to-digital conversion.

The radar signal processing unit processes the converted digital signal through a digital signal processor (DSP) and outputs distance data (range) and Doppler effect. The DSP compares the emitted FMCW radar waveform signal with the received FMCW radar waveform signal to measure a delay value and a Doppler shift, thereby measuring the distance data to the target and Doppler effect.

In addition, the radar signal processing unit converts the distance data and Doppler effect obtained by processing the digital signal into absolute coordinates (cartesian conversion) and performs angle correction according to the speed and correction according to the installation position of the radar device to ultimately generate point cloud data. The point cloud data generated by the radar signal processing unit is a four-dimensional point cloud including three-dimensional coordinates and Doppler effect.

The side radar sensor module 130 further includes a bio-signal detection unit, and the bio-signal detection unit detects from the output data of the radar signal processing unit a human's bio-signal for each sector of the detection area that is divided based on the number of seats in the width direction.

The bio-signal detection unit, when power corresponding to a bio-signal frequency is detected in each sector, determines that micro-vibration or minute movements caused by respiration or pulse, that is, a bio-signal, has been detected. In this case, in order to detect regularly-occurring signals such as respiration or pulse, the bio-signal detection unit may need to perform signal processing on signals, including previous signals, for a certain period of time. The bio-signal detection unit performs signal processing only on signals reflected from a location corresponding to a specific sector and may perform signal processing for bio-signal detection sequentially for each sector or in parallel for all sectors or for a plurality of sectors simultaneously.

Depending on the aspect of the invention, the bio-signal detection unit may perform digital beamforming on the location of each sector and then process the signal to detect bio-signals due to human respiration.

When a child enters a space under the seat inside a vehicle, a driver may not be able to check through a rearview mirror, and thus the side radar sensor module 130 may report a detection result whenever the side radar sensor module 130 detects a bio-signal in the detection area.

The side radar sensor module 130 may receive power through several wires of a cable (e.g., a UTP cable) used for connecting to a vehicle network.

The alarm indicator 120 includes a speaker that outputs an alarm sound or the like and one or more LEDs that indicate generation of an alarm. For example, the alarm indicator 120 includes a green LED and a red LED, turns on or flashes the red LED when detecting a child's bio-signal inside the vehicle, and turns on or flashes the green LED when no child's bio-signal is detected inside the vehicle.

The alarm indicator 120 receives a bio-signal detection result from the side radar sensor module 130 through the vehicle network. The side radar sensor module 130 performs bio-signal detection on a detection area, i.e., a seat row, for a preset period of time and reports a bio-signal detection result to the alarm indicator 120 regardless of whether the bio-signal is detected, or reports the bio-signal detection result to the alarm indicator 120 only when the bio-signal is detected, and the alarm indicator 120 determines whether an alarm is generated from the inside of the school vehicle based on the object detection result that has been received.

When it is determined that a bio-signal is detected inside the vehicle as a result of the determination of the bio-signal detection result, the alarm indicator 120 outputs a warning sound through a speaker and turns on or flashes one or more LEDs indicating a warning to present the warning. When it is determined that no bio-signal is detected inside the vehicle, the alarm indicator 120 turns on or flashes one or more LEDs indicating normal state to present the normal state and output a predetermined sound through the speaker.

The power supply device 110 converts ACC power and/or battery power of the vehicle into 24 V when needed and supplies the power to the radar sensor modules 130 and 140 and the alarm indicator 120 installed inside the vehicle. The power supply device 110 operates in an operating mode and a sleep mode, and when the school vehicle is started, boots and operates in the operating mode. The power supply device 110 supplies the vehicle battery power to the radar sensor modules 130 and 140. That is, when the school vehicle is started, the power supply device 110 receives power from the school vehicle, activates from the sleep mode, and supplies power to the radar sensor modules 130and 140 and the alarm indicator 120, and when the school vehicle is turned off, after a first period of time (e.g., 3 minutes), stops supplying power to the radar sensor modules 130 and 140 and the alarm indicator 120 and switches to the sleep mode to standby.

According to an additional aspect of the present invention, the safety system 10 inside a school vehicle using a radar sensor may further include a plurality of upper radar sensor modules 140.

The upper radar sensor modules 140 are installed in a plural manner on the upper portion of one side wall inside the school vehicle to detect a human bio-signal with respect to the upper side of the seat.

A single upper radar sensor module sets two rows of seats arranged in the school vehicle from the upper portion of one side wall inside the vehicle as a detection area and detects a bio-signal of a child sitting or lying on the seat. In this case, since the first row of seats may be visually confirmed by the driver, the first row of seats may be excluded from the detection area. For example, when 13 rows of seats are installed on both sides of the center aisle, 6 upper radar sensor modules may be installed, excluding the first row of seats. However, it is not limited thereto, and depending on the shape of the seat, considering the height at which the upper radar sensor module 140 is installed, etc., a single upper radar sensor module may set one seat row as a detection area or three or more seat rows as a detection area.

In addition, the detection area of the radar of a single upper radar sensor module may partially overlap the detection area of the radar of an adjacent upper radar sensor module. In this case, each upper radar sensor module may report that a bio-signal has been detected.

It is preferable that the upper radar sensor module 140 is provided using the same radar sensor module as the side radar sensor module 130. However, when needed, radar parameters set for the radars of the upper radar sensor module 140 and the side radar sensor module 130 may be different depending on the use of each radar sensor module. Therefore, the radar used by the upper radar sensor module 140 is also an ultra-short-range radar (USRR) or a short-range radar (SSR). There is no limitation on the radar operation method of the radar sensor module 140, and a pulse Doppler method, a frequency modulated continuous wave (FMCW) method, a frequency shift keying (FSK) method, an UWB method, or the like may be used.

Each of the upper radar sensor modules 140, upon detecting presence of an object whose bio-signal is detected, i.e., a child inside the vehicle, reports an object detection result through the connected vehicle network. In this case, each of the upper radar sensor modules 140 may attempt to perform bio-signal detection for a preset period of time (e.g., 30 seconds).

The upper radar sensor module 140 may be installed on the upper portion of one side wall inside the school vehicle to face the upper side of the seat, and the upper radar sensor module 140 may divide sectors according to height and detect the bio-signal in each sector.

The upper radar sensor module 140 may also be implemented as a radar and a signal processing circuit connected to an output terminal of the radar or a computing device including the signal processing circuit in a similar manner to the side radar sensor module 130. The detailed description of each configuration is as described above.

The upper radar sensor module 140 may receive power through several wires of a cable (e.g., an UTP cable) used for vehicle network connection.

According to various aspects of the present invention, when the school vehicle is turned off, the power supply device 110 transmits a bio-signal detection start control message to the alarm indicator 120 inside the school bus, and the alarm indicator 120 may transmit a bio-signal detection start control message to the radar sensor modules 130 and 140 installed inside the school vehicle during a preset first cycle.

When the engine is turned off for the children to disembark after the school vehicle stops, the power supply device 110 detects the turning-off of the engine and transmits a bio-signal detection start control message to the alarm indicator 120 to detect whether there are children who have not disembarked from the vehicle.

The alarm indicator 120 transmits a bio-signal detection start control message to the radar sensor modules installed inside the school vehicle, i.e., the side radar sensor modules 130 that have the lower side of the seat as a detection area and the upper radar sensor modules 140 that have the upper side of the seat as a detection area. In this case, the alarm indicator 120 may repeatedly transmit a bio-signal detection start control message to the radar sensor modules during the first cycle.

The radar sensor modules 130 and 140 that have received the bio-signal detection start control message attempt to detect an object for a preset period of time (e.g., 30 seconds).

In this case, the alarm indicator 120 may transmit the bio-signal detection start control message to the radar sensor modules 130 and 140 installed in the school vehicle after waiting for a second period of time by taking into consideration the time during which children disembark after the school bus stops.

As shown in FIG. 3, the plurality of radar sensor modules 130 and 140, the power supply device 110, and the alarm indicator 120 may be connected in a daisy chain form through a vehicle network and communicate with each other.

In addition, the alarm indicator 120 may transmit a control message to reset the power of a specific radar sensor module through vehicle network communication. In order to reset a specific radar sensor module that generates a false alarm, i.e., a radar sensor module that malfunctions such as detecting that there is a bio-signal even when a child is not on the vehicle, the alarm indicator transmits a power reset control message to the radar sensor module.

In this case, the radar sensor module that receives the power reset control message from the alarm indicator 120 may perform a power reset.

According to various aspects of the present invention, when at least one radar module detects a bio-signal inside a school vehicle, the alarm indicator 120 notifies a control server of the result through a mobile data terminal (MDT) inside the school vehicle. The control server notifies the person in charge of the school or relevant authorities that a bio-signal is detected inside the school vehicle, i.e., that a child remains without disembarking, such that an action may be taken.

According to the present invention, a safety system capable of detecting a bio-signal of a child remaining inside a school vehicle without disembarking from the school vehicle and generating an alarm using radar can be provided.

The various embodiments disclosed in this specification and drawings are merely presented as specific examples to help understanding and are not intended to limit the scope of the various embodiments of the present invention.

Accordingly, the scope of the various embodiments of the present invention should be interpreted as including all changes or modified forms derived based on the technical ideas of the various embodiments of the present invention in addition to the embodiments described herein.

What is claimed is:

1. A safety system inside a school vehicle using a radar sensor, comprising:
a plurality of side radar sensor modules installed on one side wall inside a school vehicle at a height corresponding to a seat level for each row of seats and configured to detect a bio-signal of a human with respect to a lower side of the seat in a direction toward the other side wall, wherein an object detection area is divided into sectors corresponding to a position of each of the seats to detect the bio-signal;
an alarm indicator configured to receive a bio-signal detection result from the radar sensor modules, determine whether an alarm has been generated from an inside of the school vehicle, and when it is determined that the alarm has been generated from the inside of the school vehicle, output a warning sound through a speaker and flash one or more light emitting diodes (LEDs) to indicate the generation of the alarm; and
a power supply device configured to, when the school vehicle is turned on, receive power from the school vehicle, activate from a sleep mode, and supply power to the radar sensor module and the alarm indicator, and when the school vehicle is turned off and a first time period has elapsed, stop supplying power to the radar sensor module and the alarm indicator, and switch to a sleep mode to standby.

2. The safety system inside the school vehicle of claim 1, further comprising a plurality of upper radar sensor modules installed on an upper portion of one side wall inside the school vehicle to detect a bio-signal of a human with respect to an upper side of the seat.

3. The safety system inside the school vehicle of claim 1, wherein the power supply device transmits a bio-signal detection start control message with respect to the inside of the school bus to the alarm indicator when the school vehicle is turned off, and
the alarm indicator transmits the bio-signal detection start control message to the radar sensor modules installed inside the school vehicle during a preset first cycle.

4. The safety system inside the school vehicle of claim 3, wherein the alarm indicator transmits the bio-signal detection start control message to the radar sensor modules installed inside the school vehicle after waiting for a second period of time.

5. The safety system inside the school vehicle of claim 1, wherein the plurality of radar sensor modules, the power supply device, and the alarm indicator are connected in a daisy chain form through a vehicle network.

6. The safety system inside the school vehicle of claim 3, wherein the alarm indicator transmits a power reset control message to reset power of a specific radar sensor module through an in-vehicle network communication, and
the radar sensor module having received the power reset control message from the alarm indicator performs a power reset.

7. The safety system inside the school vehicle of claim 1, wherein, when at least one of the plurality of radar modules detects the bio-signal inside the school vehicle, the alarm indicator notifies a control server of a result of the detection through a mobile data terminal (MDT) inside the school vehicle.
